(19) United States
(12) Patent Application Publication
(10) Pub. No.: US 2023/0135670 A1
(43) Pub. Date: May 4, 2023

(54) CLAW-TYPE GEARSHIFT AND METHOD OF SHIFTING A CLAW-TYPE GEARSHIFT

(71) Applicant: Hoerbiger Antriebstechnik Holding GmbH, Schongau (DE)

(72) Inventors: Juergen BINDER, Schongau (DE); Werner Fuerguth, Schongau (DE); Andreas Dempfle, Schongau (DE); Wolfgang Voelk, Schongau (DE); Thomas Schnelzer, Schongau (DE); Peter Echtler, Schongau (DE)

(21) Appl. No.: 18/050,199

(22) Filed: Oct. 27, 2022

(30) Foreign Application Priority Data
Oct. 28, 2021 (DE) 102021128170.9

(51) Int. Cl. F16H 63/30; F16H 63/04; F16H 61/04

(52) U.S. Cl. CPC F16H 63/30; F16H 61/0403; F16H 63/04; F16H 2063/3093

(57) ABSTRACT

In a claw-type gearshift, a blocking ring is arranged axially between a hub body having a sliding sleeve and a clutch body such that it is rotatable between a release position and two locking positions. The blocking ring is adapted to be displaced toward the clutch body until friction surfaces on the blocking ring and on the clutch body come into contact. The blocking ring constitutes a form-locking blockade for the sliding sleeve against displacement of the sliding sleeve teeth between the clutch body teeth when an axial shifting force is applied in the non-synchronized state. When the claw clutch is shifted, a difference in speed between the clutch body and the hub body is reduced and the sliding sleeve is deflected in the axial direction toward the speed change gear to be shifted, causing a friction surface of the blocking ring and a mating friction surface of the clutch body to come into contact. The blocking ring switches over in the circumferential direction into one of two possible locking positions, locking the sliding sleeve.

### TECHNICAL FIELD

The disclosure relates to a claw-type gearshift and a method of shifting a claw-type gearshift. The claw-type gearshift is provided in particular for a manual transmission of a vehicle.

### BACKGROUND

Claw-type gearshifts, i.e. shiftable claw clutches, have the drawback in motor vehicles that vibrations and noise may occur during engagement of the two coupling elements with each other when there are rotational speed differences.

The object of the disclosure is to provide a claw-type gearshift in which noise generation and wear are reduced.

### SUMMARY

The claw-type gearshift according to the disclosure includes a sliding sleeve which is adapted to be axially displaced on a hub body and includes an internal toothing having a multitude of sliding sleeve teeth, and a clutch body of a speed change gear, which includes an external toothing which has a multitude of clutch body teeth and is adapted to engage in the internal toothing of the sliding sleeve. Further provided is a blocking ring which has an external toothing and is arranged axially between the hub body and the clutch body and which is fixed to the hub body such that it is rotatable in relation to the sliding sleeve by a certain degree in the circumferential direction between a release position and two locking positions, the locking positions being located on either side of the release position in the circumferential direction. Arranged on the hub body are a plurality of thrust pieces which are coupled to the sliding sleeve and are movable toward the clutch body, and the blocking ring is adapted to be displaced toward the clutch body by the thrust pieces until a friction surface of the blocking ring comes to rest against a mating friction surface of the clutch body. The blocking ring constitutes a form-locking blockade for the sliding sleeve against displacement of the sliding sleeve teeth between the clutch body teeth when an axial shifting force is applied in the non-synchronized state.

Similar to a synchronizer ring of a known synchronized gearshift, in this entirely different application the blocking ring prevents the sliding sleeve from striking the clutch body at a high differential speed. The blocking ring allows the sliding sleeve toothing to engage with the clutch body toothing only after an adaption of the speeds, which, however, is preferably not effected by the blocking ring itself, but away from the claw-type gearshift. In this way, noise generation and component wear are significantly reduced.

In contrast to the known synchronized gearshifts, however, no provision is made for the sliding sleeve to be able to actively return the blocking ring to its release position in order to allow engagement. For this purpose, in particular the blocking ring teeth and the sliding sleeve teeth are formed and located opposite each other in the locking position in such a way that when a shifting force has been applied axially, the sliding sleeve cannot return the blocking ring to the release position. For example, the axial ends of the blocking ring teeth and the sliding sleeve teeth that meet are flattened. Also, as extensive an overlap as possible of the blocking ring teeth and the sliding sleeve teeth in the circumferential direction in the locking position contributes to ensuring that, with an axial shifting force applied, the resulting force components in the circumferential direction remain so small that no rotation of the blocking ring back to the release position occurs.

Returning the blocking ring is preferably effected by a rotational speed crossing, that is, a change in direction of the relative rotational speed of the clutch body and the hub body after a zero crossing.

There are two possible scenarios for this. For one thing, the relative rotational speed experiences a change in direction when one component, that is, the clutch body or the hub body, which was previously leading the other, now lags behind it, but both components maintain their previous absolute direction of rotation. For another thing, the relative rotational speed also changes direction when one of the components, that is, the clutch body or the hub body, changes its absolute direction of rotation.

In either case, the frictional torque also undergoes a change of direction.

Particularly good locking is achieved when the tooth centers of the blocking ring teeth and the sliding sleeve teeth are opposite each other in each of the locking positions as viewed in the axial direction, that is, when the tooth centers are in the same position in the circumferential direction. The occurrence of lateral force components that might cause a rotation of the blocking ring to the release position can be minimized in this way.

In the release position, the tooth centers of the blocking ring teeth are then correspondingly located centrally in the tooth gaps of the internal toothing of the sliding sleeve.

The blocking ring may have a radially oriented, planar friction surface, and the clutch body may have a radially oriented, planar mating friction surface.

Such a blocking ring has a very narrow design in the axial direction and is cost-effective to manufacture.

In one possible variant, the axial ends of the blocking ring teeth all have a flat configuration, i.e. they have no portion that protrudes in the axial direction, and they form a flat, radially oriented surface, thus reducing manufacturing costs.

To increase the frictional forces between the blocking ring and the clutch body, the friction surface of the blocking ring is optionally provided with a friction lining. This is a simple and cost-effective way of ensuring that the frictional forces between the friction surface on the blocking ring and the mating friction surface on the clutch body are always higher than the frictional forces between the axial ends of the sliding sleeve teeth and the blocking ring teeth, so that the changeover movement of the blocking ring cannot be influenced by the sliding sleeve teeth.

In another variant, pointing surfaces are provided at the axial ends of some or all of the blocking ring teeth and/or the sliding sleeve teeth, the pointing surfaces having an opening angle perpendicular to a tooth longitudinal direction in the axial direction that is equal to or smaller than 7 degrees.

These pointing surfaces serve to reduce the frictional forces between the sliding sleeve and the blocking ring in the circumferential direction to a value that is smaller than the frictional force between the friction surface of the blocking ring and the mating friction surface of the clutch body. This is effected by the working angle of the pointing surfaces, which generate a small circumferential force component due to the inclination in the tangential direction, to compensate for the frictional forces.

In this context, the opening angle should be selected to be so small that the frictional forces acting between the sliding sleeve and the blocking ring in the axial direction are always greater than the force that is generated by an axial shifting force and seeks to rotate the blocking ring in the circumferential direction.

The opening angle is in the range of the respective self-locking angle of the material pairing between the blocking ring and the sliding sleeve. For example, for a steel-on-steel frictional contact, the coefficient of friction µ amounts to 0.1, resulting in a self-locking angle of 5.7 degrees. Compared with the engagement slopes of about 60 degrees conventionally used in synchronizer rings, this means that the pointing surfaces are formed with an extremely small angle.

It has been found that with an opening angle of equal to or smaller than 7 degrees it is made sure for all common material pairings and normal shifting forces that the sliding sleeve is not capable of rotating the blocking ring from its locking position back to the release position.

Since in a claw clutch the sliding sleeve teeth and the clutch body teeth are normally formed without engagement slopes, the axial installation space required for the claw-type gearshift is reduced.

In order to prevent the blocking ring from rotating beyond the release position as far as to the opposite locking position in the locked position of the claw clutch when the blocking ring is returned to the release position, a blocking ring detent may be provided which limits a rotation of the blocking ring in the circumferential direction to a greater extent than the fixing in place, provided for switching the blocking ring over, of the blocking ring on the hub body.

In particular, the blocking ring may have at least one recess that extends in the circumferential direction and is divided in the middle into two portions by a radial projection. At least one of the thrust pieces includes an axially projecting pin arranged to engage in one of the portions of the recess when the blocking ring is in one of the locking positions. The recess is formed such that the blocking ring can only move between the respective locking position and the release position. As soon as the blocking ring switches over due to the frictional contact between the blocking ring and the clutch body and is thus tied down to one locking position, the pin of the thrust piece engages in one of the portions of the recess. This limits the range of movement of the blocking ring to that portion of the recess. As a result, the blocking ring can move only as far as the release position during the restoring movement, in particular in a rotational speed crossing of the hub body or the clutch body, but cannot move beyond this position in the circumferential direction.

When the pin strikes against the central projection, the blocking ring is in the release position.

The width of the portions of the recess in the circumferential direction should be dimensioned such that the movement range of the pin corresponds to half the angular position between the two locking positions. Since in the release position the sliding sleeve teeth rest in the gaps of the blocking ring toothing and in each of the two locking positions the blocking ring teeth are preferably exactly opposite the sliding sleeve teeth, the movement range corresponds in particular to half the angular distance between neighboring blocking ring teeth.

Preferably, the recess is arranged on a radially inner side of the blocking ring.

Of course, the blocking ring detent could also be implemented in the reverse form, and a recess split into two parts could be arranged on the thrust piece, while an axially projecting pin which engages in one of the portions of the recess is provided on the blocking ring.

The above-mentioned object is also achieved by a method of shifting a claw-type gearshift, in particular a claw-type gearshift as described above. The claw-type gearshift includes a sliding sleeve adapted to be axially displaced on a hub body, a clutch body of a speed change gear, which is adapted to move into engagement with the sliding sleeve, and a blocking ring arranged axially between the hub body and the clutch body. A difference in speed between the clutch body and the hub body is reduced. A shifting force is applied, and the sliding sleeve is deflected in the axial direction toward the speed change gear to be shifted, causing the friction surface of the blocking ring and the mating friction surface of the clutch body to come into contact. The blocking ring switches over in the circumferential direction to one of two possible locking positions by the frictional connection with the clutch body, so that a further axial movement of the sliding sleeve is blocked by the external toothing of the blocking ring. Subsequently, the blocking ring switches back to the release position in the circumferential direction when a change in direction of the relative rotational speeds of the clutch body and the hub body is performed, and the internal toothing of the sliding sleeve is engaged with the external toothing of the clutch body.

Returning the blocking ring to the release position is effected exclusively by the blocking ring being entrained by the clutch body or the hub body when one of these components experiences a rotational speed crossing.

As long as the hub body and the clutch body rotate in the same direction at differential speeds, the blocking ring preferably blocks an axial further movement of the sliding sleeve irrespective of the shifting force acting.

Preferably, in the locking position, a rotation of the blocking ring is limited to an angular distance between the respective locking position and the release position to prevent the blocking ring from switching over beyond the release position and into the opposite locking position. This can be achieved, for example, using a blocking ring detent as described above.

If a tooth-on-tooth position occurs at the first contact between the sliding sleeve teeth and the clutch body teeth, a relative rotation between the hub body and the clutch body, which allows the internal toothing of the sliding sleeve to engage with the external toothing of the clutch body, is advantageously achieved by a speed difference between the hub body and the clutch body that builds up after rotational speed crossing. Normally, a small speed difference necessarily arises after only a short time following rotational speed crossing. Therefore, the clutch body and the sliding sleeve will automatically move to a tooth-on-gap position.

At this point in time, the blocking ring is already in its release position and no longer blocks the sliding sleeve. It is also of advantage that the speed adaption need not be designed such that it leads to completely identical speeds of the hub body and the clutch body.

In particular, the adaption of the speeds of the hub body and the clutch body is not effected by the blocking ring, but through a device which is separate from the blocking ring and can be implemented at a suitable location in the vehicle away from the claw-type gearshift. The speed adaption is preferably initiated before the shifting force is applied and the sliding sleeve is moved, so that the blocking ring does not come into contact with the clutch body until the speeds have already been largely matched. The blocking ring therefore only has to withstand very small speed differences, so it can be constructed significantly thinner than a conventional synchronizer ring, which saves both axial installation space and material.

### BRIEF DESCRIPTION OF THE DRAWINGS

FIG. 1 shows a schematic exploded view of a claw-type gearshift according to the disclosure for carrying out a method according to the disclosure;

FIG. 2 shows a schematic partly sectional view of the claw-type gearshift of FIG. 1;

FIG. 3 shows a schematic illustration of a variant of the shape of the blocking ring teeth and the sliding sleeve teeth of the claw-type gearshift of FIG. 1;

FIGS. 4 and 5 show schematic views of the claw-type gearshift from FIG. 1 in a neutral position, with the blocking ring in its release position;

FIGS. 6 and 7 show schematic views of the claw-type gearshift from FIG. 1 in a locked position, with the blocking ring in one of its locking positions;

FIG. 8 shows a schematic illustration of the claw-type gearshift from FIG. 1 in a docking position, in which the sliding sleeve is in engagement with the clutch body; and

FIG. 9 shows a schematic illustration of a blocking ring detent of the claw-type gearshift of FIG. 1.

### DETAILED DESCRIPTION

For the sake of clarity, where components are shown more than once in the drawings, not all of them are provided with reference numbers.

The claw-type gearshift 10 illustrated in the figures, which is designed here for a manual transmission of a motor vehicle, serves to optionally connect a rotatable shaft to a speed change gear (not shown) for joint rotation therewith. The shaft carries a hub body 12, which is connected to said shaft for joint rotation therewith, while a clutch body 14 is attached to the speed change gear for permanent joint rotation therewith.

The hub body 12 includes an external toothing 16 that is permanently in engagement with an internal toothing 18 of a sliding sleeve 20 that surrounds the hub body 12 in the circumferential direction U.

The sliding sleeve 20 is displaceable in the axial direction A by a certain degree to either side of the hub body 12, with the toothings 16, 18 remaining in engagement with each other at all times. The sliding sleeve 20 is axially displaceable so far that the internal toothing 18 comes to engage in an external toothing 22 of the clutch body 14.

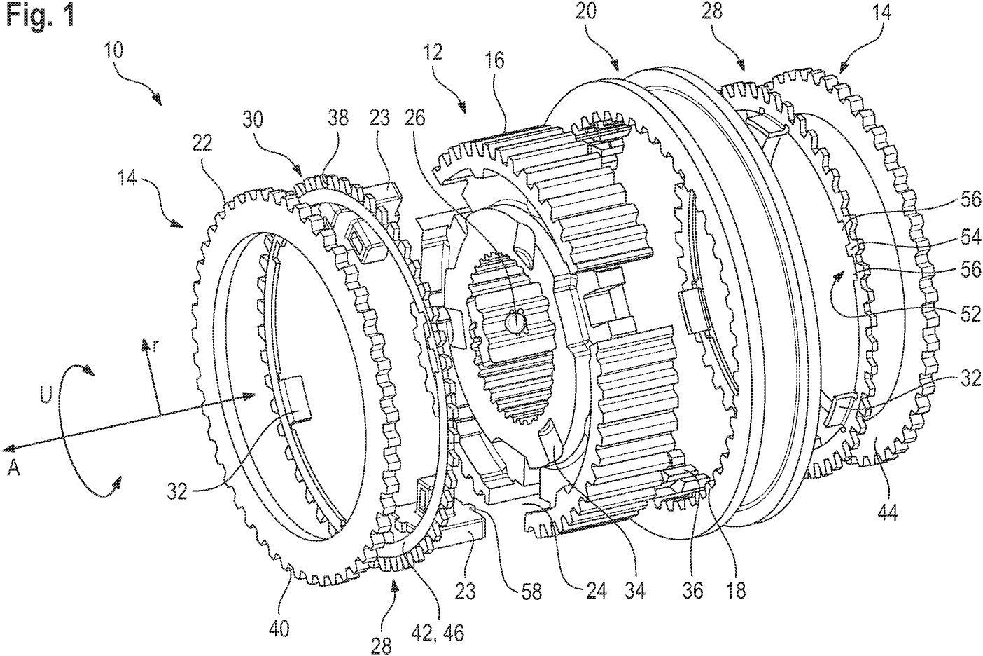

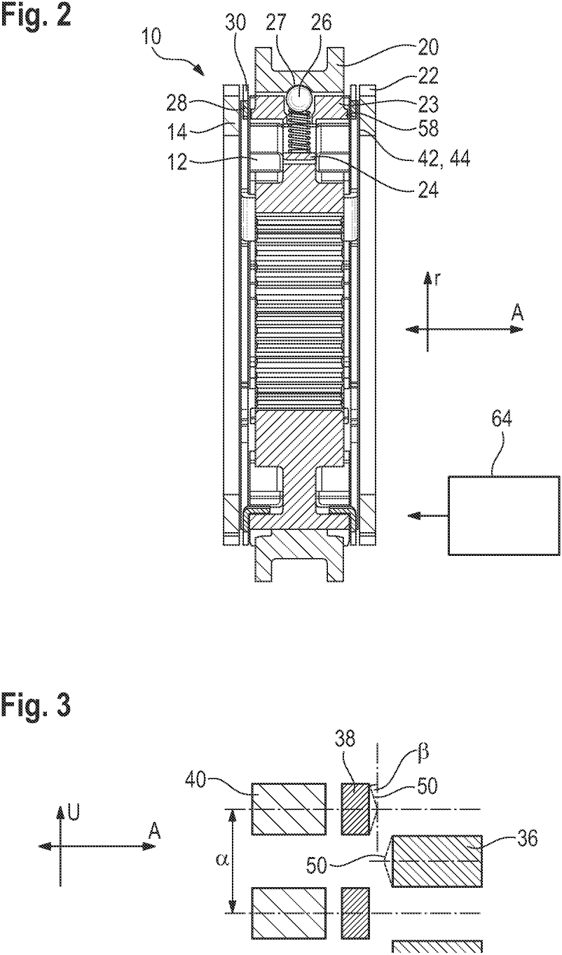

As is illustrated in FIG. 1, as a rule, two speed change gears, each with a clutch body 14, are arranged on either side of the hub body 12 so that two gears can be shifted by the axial movement of the sliding sleeve 20.

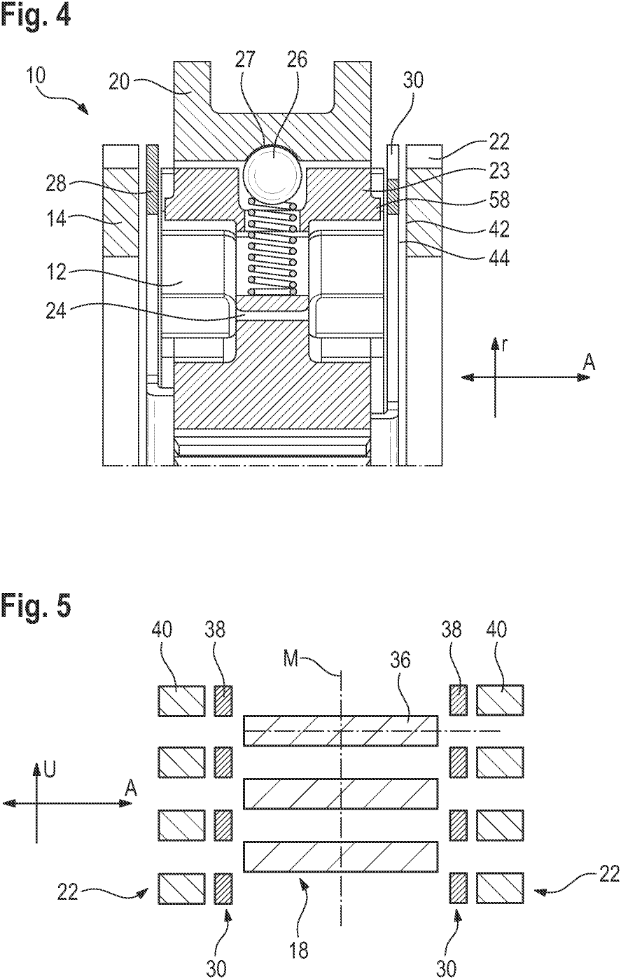

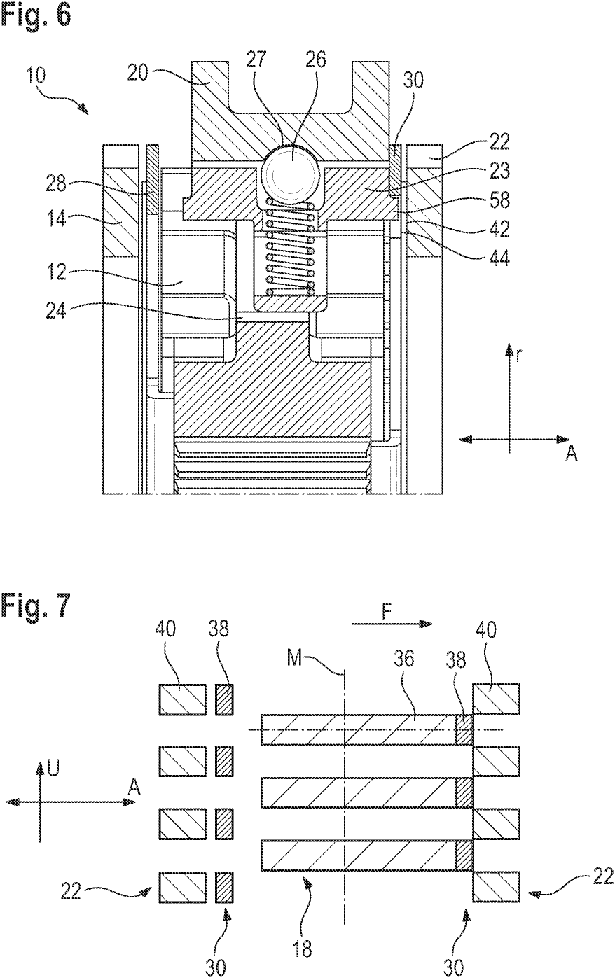

In a circumferential surface of the hub body 12, a plurality of thrust pieces 23, in this case three, are arranged so as to be evenly distributed over the circumference and are each accommodated in a radial retainer 24 and are movable to a certain degree in both directions in the axial direction A, but are fixed in place in the circumferential direction U. Each of the thrust pieces 23 has a ball 26 accommodated therein, which can be pressed into the thrust piece 23 in the radial direction r against a spring tension. The thrust pieces 23 cooperate with the sliding sleeve 20 in a known manner. In a neutral position, the balls 26 engage in a latching groove 27 on the inside of the sliding sleeve 20, so that the thrust pieces 23 are deflected axially when the sliding sleeve 20 is displaced (see FIGS. 4 and 6). When the internal toothing 18 of the sliding sleeve 20 engages with the external toothing 22 of the clutch body 14, the balls 26 are pressed into the respective thrust piece 23 so that the sliding sleeve 20 can slide thereover.

In the axial direction A, a respective blocking ring 28 having an external toothing 30 is arranged between the clutch body 14 and the hub body 12.

The blocking ring 28 has a plurality of axially projecting coupling tabs 32 which are distributed over its circumference and which are in permanent engagement with corresponding coupling grooves 34 in a side surface of the hub body 12. The coupling grooves 34 are made to be so wide in the circumferential direction U that the coupling tabs 32 and thus the blocking ring 28 can rotate by a certain angular measure in both directions to two locking positions in relation to a central release position. In each of the locking positions, the coupling tabs 32 rest against a circumferential edge of the coupling grooves 34.

The toothings 18, 22, 30 of the sliding sleeve 20, the clutch body 14 and the blocking ring 28 all have dimensions that are matched to each other, so that the sliding sleeve teeth 36 can engage between the blocking ring teeth 38 and the clutch body teeth 40.

Here, the blocking ring teeth 38 have roughly the same dimensions in the circumferential direction U as the clutch body teeth 40; in the release position, the tooth gaps of the external toothing 30 of the blocking ring 28 and the external toothing 22 of the clutch body 14 are in alignment, and in each of the locking positions, the blocking ring teeth 38 lie in the gaps between the clutch body teeth 40, thus blocking the axial movement of the sliding sleeve 20.

As shown in FIG. 7, the blocking ring teeth 38 and the sliding sleeve teeth 36 are in the same position in the locking positions in the circumferential direction U. The shifting force F therefore acts centrally on the blocking ring teeth 38.

The angle α between the two locking positions comprises one tooth spacing (from tooth center to tooth center) of the external toothing 22 of the clutch body 14, which here also corresponds to the spacing of the teeth of the external toothing 30 of the blocking ring 28 (see also FIG. 9). The clearance of the coupling tabs 32 in the coupling grooves 34 in the circumferential direction U accordingly amounts to one tooth spacing of the external toothing 22 of the clutch body 14.

On its side facing the clutch body 14, the blocking ring 28 is provided with a friction surface 42, which can cooperate with a mating friction surface 44 on the clutch body 14.

In the examples shown here, both the friction surface 42 and the mating friction surface 44 are flat and extend exclusively in the radial direction r and in the circumferential direction U.

The friction surface 42 here is provided with a friction lining 46, which is applied to the friction surface 42 as a coating and which increases the friction with the mating friction surface 44.

In general, one or both of the friction surfaces 42, 44 may be formed only by the surface of the material of the blocking ring 28 or of the clutch body 14, with a suitable structuring, for example a grooved structure, if required. In addition, one or both of the friction surfaces 42, 44 may also be provided with a friction-enhancing and/or wear-reducing coating.

In the variant shown in FIG. 1, all of the blocking ring teeth 38 are formed to be axially flat.

It would, however, be possible to provide axial pointing surfaces 50 having an opening angle β perpendicular to the tooth longitudinal direction and the axial direction A in the range of the respective self-locking angle, in particular equal to or smaller than 7 degrees, on some or all blocking ring teeth 38 and/or sliding sleeve teeth 36 in order to adjust the frictional properties (see FIG. 3).

The axial ends of the clutch body teeth 40 are always flat here.

It is not intended that the sliding sleeve 20 can actively rotate the blocking ring 28 back to its release position. When the blocking ring 28 is in one of the locking positions, the sliding sleeve 20 is prevented from moving axially further toward the associated clutch body 14, irrespective of the axial shifting force applied.

The blocking ring teeth 38 and also the sliding sleeve teeth 36 as well as the clutch body teeth 40 are formed entirely without engagement slopes.

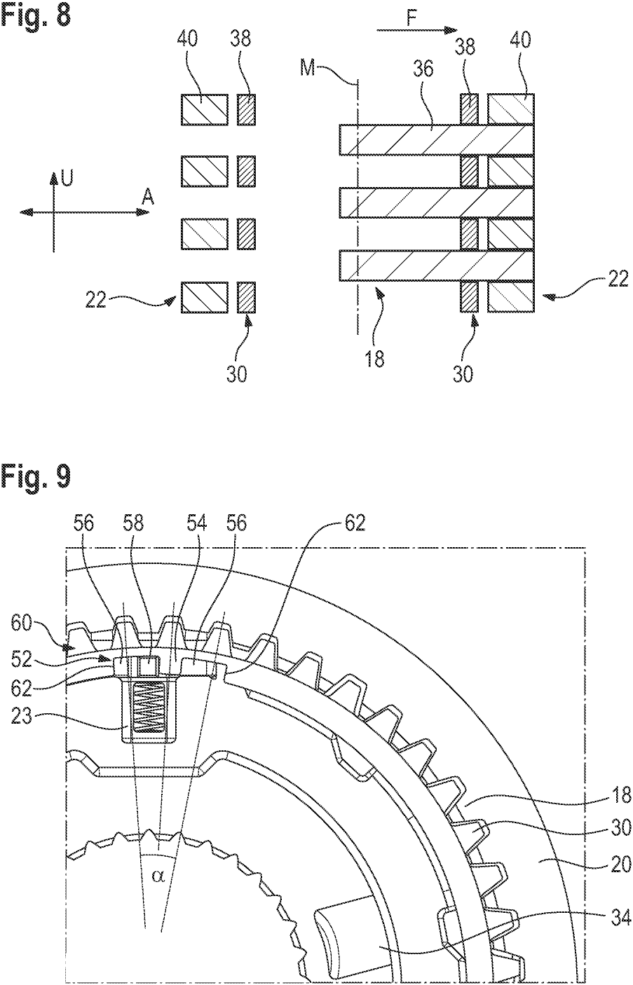

On its inner circumference, the blocking ring 28 has a plurality of recesses 52, which are each divided into two adjoining portions 56 by a central radial projection 54 (see FIGS. 1 and 8). The positions of the recesses 52 are coordinated with the positions of the thrust pieces 23 in the circumferential direction U. Each of the thrust pieces 23 includes an axially projecting pin 58, which is arranged in the center of the thrust piece 23 with respect to the circumferential direction U. In the release position, the pin 58 is located opposite the projection 54.

The recesses 52 and the pins 58 together form a blocking ring detent 60 that prevents the blocking ring 28 from rotating back beyond the release position when the claw-type gearshift 10 is in the locked position.

As shown in FIGS. 6 and 9, when the claw-type gearshift 10 is in the locked position, the pin 58 engages in one of the two portions 56 of the recesses 52. In this way, a rotation of the blocking ring 28 is limited to the area between the release position, in which the pin 58 rests against the projection 54, and one of the two locking positions, in which the pin 58 rests against the lateral circumferential edge 62 of the respective portion 56. Thus, rotation of the blocking ring 28 is restricted to an angular distance α/2 between the respective locking position and the release position when the blocking ring 28 is in one of its locking positions.

Referring to FIGS. 4 to 9, the operation of the claw-type gearshift 10 will now be described.

FIGS. 4 and 5 show the claw-type gearshift 10 in a neutral position, in which the blocking ring 28 is in its release position. The sliding sleeve 20, the blocking ring 28 and the clutch body 14 are axially spaced apart from each other and do not touch. The blocking ring 28 has a small axial clearance with respect to both the sliding sleeve 20 and the clutch body 14.

The sliding sleeve 20 is located centrally between the two clutch bodies 14, which is illustrated by the dashed centerline M in FIG. 5.

As shown in FIG. 5, the toothings 22, 30 of the blocking ring 28 and the clutch body 10 are congruent, and the sliding sleeve teeth 36 are located in the gaps of the toothings 22, 30 in the circumferential direction U.

To shift a gear, first the speeds of the hub body 12 and of the clutch body 14 which is to be coupled to the sliding sleeve 20 are largely approximated by a device 64 for speed adaption. The device 64 may, for example, be coupled to an electric motor of the vehicle and does not comprise the blocking ring 28.

Only when this substantial speed adaption has been effected is an axial shifting force F applied, to the right in the Figures. The sliding sleeve 20 is displaced a short distance in the axial direction A, entraining the balls 26 of the thrust pieces 23 in the axial direction A, which in turn axially deflects the thrust pieces 23. The thrust pieces 23 act axially on the blocking ring 28, causing the friction surface 42 to come into contact with the mating friction surface 44. This frictional contact causes the clutch body 14 to entrain the blocking ring 28 in the circumferential direction U, so that the latter switches over from its release position to one of the locking positions. This is shown in FIGS. 6 and 7. The blocking ring teeth 38 are now located in front of the gaps in the external toothing 22 of the clutch body 14 and centrally in front of the sliding sleeve teeth 36 in the circumferential direction U.

The blocking ring 28 does not take over the function of speed adaption between the hub body 12 and the clutch body 14. This is performed practically exclusively by the device 64. The blocking ring 28 is moved to one of its locking positions only by the remaining residual difference in speed.

The claw-type gearshift 10 is now in a locked position, in which the sliding sleeve 20 cannot move any further in the axial direction A toward the clutch body 14.

The amount of frictional force between the friction surface 42 and the mating friction surface 44 here is selected to be higher than the frictional force that now develops between the sliding sleeve 20 and the blocking ring 28. This may be achieved, for example, by the friction lining 46 on the friction surface 42. Alternatively or additionally, this can be ensured by the pointing surfaces 50 already described above (see FIG. 3). Where pointing surfaces 50 are provided, the surface of contact between the sliding sleeve toothing 18 and the blocking ring 28 is reduced to line contacts, which significantly reduces the frictional force in the circumferential direction U, which is not desired at this location. This prevents the sliding sleeve 20 from possibly entraining the blocking ring 28 in the circumferential direction U, since the frictional force between the blocking ring 28 and the clutch body 14 always predominates.

The axial movement of the thrust piece 23 causes the pin 58 to move into one of the portions 56 of the recess 52 in the blocking ring 28. Since the blocking ring 28 is in one of its locking positions, the pin 58 rests against one of the two lateral circumferential edges 62 of the recess 52.

The device 64 further acts to adapt the speeds of the hub body 12 and the clutch body 14. In the process, after a short period of time, a rotational speed crossing of the hub body 12 or of the clutch body 14 will occur.

This change in the direction of rotation causes the blocking ring 28 to rotate back to the release position in the circumferential direction U, resulting in the docking position shown in FIG. 8.

The sliding sleeve 20 now can be moved further in the axial direction A, with its internal toothing 18 engaging with the external toothing 22 of the clutch body 14.

The blocking ring 28 remains in its release position, since the pin 58 now rests against the projection 54 and prevents further rotation of the blocking ring 28 to the opposite locking position (see also FIG. 9).

The rotational speed crossing is also always accompanied by the build-up of a new, small speed differential between the hub body 12 and the clutch body 14. This ensures that the sliding sleeve 20 and the clutch body 14 automatically move to a position in which the sliding sleeve teeth 36 meet the gaps in the external toothing 22 of the clutch body 14, even if there should be a tooth-on-tooth position at the first contact.

The blocking ring 28 is not involved in this process.

With its compact axial type of construction, the claw-type gearshift 10 allows a low-noise and low-wear shifting, since the movement of the sliding sleeve 20 is blocked until a rotational speed crossing has taken place. The blocking ring 28 used is not employed for speed adaption here and may therefore be manufactured to have a low material thickness.

1. A claw-type gearshift, comprising:
a sliding sleeve which is adapted to be axially displaced on a hub body and includes an internal toothing having a multitude of sliding sleeve teeth, and a clutch body of a speed change gear, which includes an external toothing which has a multitude of clutch body teeth and is adapted to engage in the internal toothing of the sliding sleeve, and
a blocking ring which has an external toothing and is arranged axially between the hub body and the clutch body and which is fixed to the hub body such that it is rotatable in relation to the sliding sleeve by a certain degree in the circumferential direction between a release position and two locking positions, the locking positions being located on either side of the release position in the circumferential direction,
wherein arranged on the hub body are a plurality of thrust pieces which are coupled to the sliding sleeve and are movable toward the clutch body, and the blocking ring is adapted to be displaced by the thrust pieces toward the clutch body until a friction surface of the blocking ring comes to rest against a mating friction surface of the clutch body, and
wherein the blocking ring constitutes a form-locking blockade for the sliding sleeve against displacement of the sliding sleeve teeth between the clutch body teeth when an axial shifting force is applied in the non-synchronized state.

2. The claw-type gearshift according to claim 1, wherein the blocking ring has a radially oriented, planar friction surface and the clutch body has a radially oriented, planar mating friction surface.

3. The claw-type gearshift according to claim 1, wherein the friction surface of the blocking ring is provided with a friction lining.

4. The claw-type gearshift according to claim 1, wherein the axial ends of the blocking ring teeth and/or the sliding sleeve teeth are configured to be either axially flat or with axial pointing surfaces having an opening angle perpendicular to a tooth longitudinal direction that is equal to or smaller than 7 degrees.

5. The claw-type gearshift according to claim 1, wherein the sliding sleeve teeth and the clutch body teeth are formed without engagement slopes.

6. The claw-type gearshift according to claim 1, wherein a blocking ring detent is provided which limits a rotation of the blocking ring in the circumferential direction to a greater extent than the fixing in place, provided for switching over the blocking ring, of the blocking ring on the hub body.

7. The claw-type gearshift according to claim 6, wherein the blocking ring has at least one recess that extends in the circumferential direction and is divided in the middle into two portions by a radial projection, and at least one of the thrust pieces has an axially projecting pin arranged to engage in one of the portions of the recess when the blocking ring is in one of the locking positions, and wherein the recess is formed such that the blocking ring can only move between the respective locking position and the release position.

8. The claw-type gearshift according to claim 1, wherein the claw-type gearshift is for a manual transmission.

9. A method of shifting a claw-type gearshift having a sliding sleeve adapted to be axially displaced on a hub body, a clutch body of a speed change gear, which is adapted to move into engagement with the sliding sleeve, and a blocking ring arranged axially between the hub body and the clutch body, in particular according to any of the preceding claims, comprising :
reducing a difference in speed between the clutch body and the hub body;
applying a shifting force and deflecting the sliding sleeve in the axial direction toward the speed change gear to be shifted, causing friction surfaces of the blocking ring and of the clutch body to come into contact;
switching the blocking ring over in the circumferential direction to one of two locking positions by the frictional connection with the clutch body, so that a further axial movement of the sliding sleeve is blocked by the external toothing of the blocking ring;
switching the blocking ring over in the circumferential direction to the release position when a change in direction of the relative rotational speeds of the clutch body and the hub body is performed; and
engaging the internal toothing of the sliding sleeve with the external toothing of the clutch body.

10. The method according to claim 9, wherein in the locking position, a rotation of the blocking ring is restricted to an angular distance between the respective locking position and the release position.

11. The method according to claim 9, wherein the blocking ring blocks an axial further movement of the sliding sleeve irrespective of the shifting force acting, and a relative rotation between the hub body and the clutch body, which allows the internal toothing of the sliding sleeve to engage with the external toothing of the clutch body, is achieved by a difference in speed between the sliding sleeve and the clutch body that builds up after the rotational speed crossing.

12. The method according to claim 9, wherein the internal toothing of the sliding sleeve has a multitude of sliding sleeve teeth, and the external toothing of the clutch body has a multitude of clutch body teeth, and
the blocking ring has an external toothing and is arranged axially between the hub body and the clutch body and which is fixed to the hub body such that it is rotatable in relation to the sliding sleeve by a certain degree in the circumferential direction between a release position and two locking positions, the locking positions being located on either side of the release position in the circumferential direction,
wherein arranged on the hub body are a plurality of thrust pieces which are coupled to the sliding sleeve and are movable toward the clutch body, and the blocking ring is adapted to be displaced by the thrust pieces toward the clutch body until a friction surface of the blocking ring comes to rest against a mating friction surface of the clutch body, and
wherein the blocking ring constitutes a form-locking blockade for the sliding sleeve against displacement of the sliding sleeve teeth between the clutch body teeth when an axial shifting force is applied in the non-synchronized state.
